(19) United States
(12) Patent Application Publication
(10) Pub. No.: US 2004/0160630 A1
(43) Pub. Date: Aug. 19, 2004

(54) Image printing system

(75) Inventors: Norio Iriyama, Tokyo (JP); Tetsuya Niitsuma, Tokyo (JP)

Correspondence Address: Finnegan, Henderson, Farabow,, Garrett & Dunner, L.L.P., 1300 I Street, N.W., Washington, DC, 20005-3315, US

(73) Assignee: KONICA MINOLTA HOLDINGS, INC.

(21) Appl. No.: 10/758,084

(22) Filed: Jan. 16, 2004

(30) Foreign Application Priority Data
Jan. 20, 2003 (JP) 2003-011309
Jan. 20, 2003 (JP) 2003-011310
Feb. 18, 2003 (JP) 2003-039691

(51) Int. Cl. G06F 3/12; G06F 15/00

(52) U.S. Cl. 358/1.15; 358/1.9

(57) ABSTRACT

This invention relates to an image printing system in which an image printing apparatus and an information processing apparatus are connected with each other through a network. The image printing apparatus has image reading means for obtaining image data by reading an image from an original, image printing means for printing an image on a paper sheet on the basis of image data, and first image processing means for performing an image process for image data. The information processing apparatus has second image processing means for performing an image process for image data. The image printing system comprises: search key input means for allowing a user to input a search key used for a search for an image processing function; search means for searching for at least an image processing function, of image processing functions provided by said first and second image processing means, which is provided by said second image processing means by using the search key input by said search key input means; and search result display means for displaying the image processing function searched out by said search means in an operation window.

### BACKGROUND OF THE INVENTION

1. Field of the Invention

The present invention relates to an image printing system and, more particularly, to an image printing system formed by connecting an image printing apparatus to an information processing apparatus through a network.

2. Description of the Prior Art

Conventionally, an image printing apparatus such as a digital copying machine has been known well, which has an image reading unit which reads an image from an original on which an image is recorded and outputs the read image as image data and an image printing unit which prints an image on a paper sheet or the like on the basis of the image data.

In such an image printing apparatus, a simple image process such as trimming is performed for the image data read by the image reading unit, and the image printing unit can print an image on the basis of the image data having undergone the image process.

Conventionally, an image printing system used in a network environment has been provided.

This image printing system is formed by connecting, through a network, an image printing apparatus such as a digital copying machine to an information processing apparatus, e.g., a personal computer or workstation, which instructs the image printing apparatus to scan (read) an image and print it. This system can also employ an arrangement in which a plurality of image printing apparatuses and a plurality of information processing apparatuses are connected to a network.

It is known that this image printing system is used in the scanner mode in which the information processing apparatus instructs the image printing apparatus to read an image, and the image printing apparatus transfers the read image to the information processing apparatus.

In the conventional image printing system, the image data of the image read by the image printing apparatus in this scanner mode is transferred to the information processing apparatus, and the information processing apparatus which has received the image data can directly store the image data as an image file in, for example, a hard disk or transfer the image file to the image printing apparatus to print the image, as needed.

Japanese Unexamined Patent Publication No. 2001-333237 discloses an image printing system which can execute various types of image processes for image data in an image printing apparatus, or can execute image processes for the image data in an information processing apparatus upon transferring it to the information processing apparatus through a network.

The conventional image printing system described in patent reference 1 described above is designed to be capable of performing distributed processing of image processes or enhancing the processing function. However, no disclosure is made as to user interfaces.

For this reason, in the conventional image printing system, when many types of image processes are provided for a user, the user is required to perform cumbersome operation in selecting and designating a target image process.

When, for example, many image processes having similar names are provided for the user, he/she cannot clearly know which is a desired image process, and hence cannot know what image is obtained by executing the image process for the image data. This confuses the user when he/she selects an image process.

Some image process requires various kinds of parameters to be input in order to be executed. With regard to an image process provided by an information processing apparatus connected to a network, when an image printing apparatus requests the user to input various kinds of parameters, the image printing apparatus needs to make an inquire to the information processing apparatus. No specific disclosure has been made regarding the implementation of such operation.

In addition, some image process exhibits different effects depending on the parameters set when the process is executed. When, for example, density adjustment is to be performed for image data, the output image data-may totally differ from the expected one depending the density level in adjustment as a parameter. Conventionally, even in such a case, the user cannot know the process result before the actual execution of the image process. That is, the conventional system is unfriendly and difficult for the user to use.

As various image processing functions are provided for the user by the image printing apparatus and information processing apparatus, although it is preferable that many types of functions be provided for the user, the user takes a lot of troubles in finding a desired function.

### SUMMARY OF THE INVENTION

The present invention has been made in consideration of the above points, and has as its object to provide an image printing system constituted by an image printing apparatus and information processing apparatus which are connected to a network, which allows a user to easily find, select, and execute a desired function of the image processing functions which can be provided for the user by the image printing apparatus or information processing apparatus.

In order to achieve the above object, according to the first aspect of the present invention, there is provided an image printing system formed by connecting, through a network, an image printing apparatus which prints an image on a paper sheet on the basis of image data to an information processing apparatus which performs an image process for the image data, the image printing apparatus including an image data transmission unit which transmits image data and a type of image process to be performed for the image data to the information processing apparatus, and the information processing apparatus including an image processing unit which performs a requested image process for image data received from the image printing apparatus, and a processed image data transmission unit which transmits the image data having undergone an image process by the image processing unit to the image printing apparatus from which the image process has been requested, wherein the information processing apparatus further includes a HELP file transmission unit which transmits, to the image printing apparatus, a HELP file which is an explanation of an image process to be executed by the image processing unit, and the image printing apparatus further includes an explanation display unit which displays the explanation of the image process on the basis of the HELP file received from the information processing apparatus.

According to the second aspect of the present invention, there is provided an image printing system formed by connecting, through a network, an image printing apparatus which prints an image on a paper sheet on the basis of image data to an information processing apparatus which performs an image process for the image data, the image printing apparatus including an image data transmission unit which transmits image data and a type of image process to be performed for the image data to the information processing apparatus, and the information processing apparatus including an image processing unit which performs a requested image process for image data received from the image printing apparatus, and a processed image data transmission unit which transmits the image data having undergone an image process by the image processing unit to the image printing apparatus from which the image process has been requested, wherein the information processing apparatus further includes a parameter type file transmission unit which transmits, to the image printing apparatus, a parameter type file in which a type of parameter necessary for execution of an image process to be executed by the image processing unit is written, and the image printing apparatus further includes a parameter input requesting unit which requests a user to input a parameter necessary for execution of an image process on the basis of a parameter type file received from the information processing apparatus.

According to the third aspect of the present invention, there is provided an image printing system formed by connecting, through a network, an image printing apparatus which prints an image on a paper sheet on the basis of image data to an information processing apparatus which performs an image process for the image data, wherein the image printing apparatus includes an operation unit which displays information to a user and receives an information input from the user, and a control permission unit which permits the information processing apparatus to gain control of the operation unit in accordance with a request from the information processing apparatus, and the information processing apparatus includes a control requesting unit which requests control of the operation unit of the image printing apparatus, and an operation unit control unit which controls the operation when control of the operation unit is permitted by the control permission unit.

According to the fourth aspect of the present invention, there is provided an image printing system in which the operation unit control unit described in the third aspect includes a sample display unit which displays, on the operation unit, a sample image obtained by causing the operation unit to perform an image process designated by the user for an original image.

According to the fifth aspect of the present invention, there is provided an image printing system in which the operation unit control unit described in the fourth aspect further includes a sample display selection unit which allows the user to select whether or not to cause the sample display unit to display a sample.

According to the sixth aspect of the present invention, there is provided an image printing system formed by connecting, through a network, an image printing apparatus to an information processing apparatus, the image printing apparatus including an image reading unit which obtains image data by reading an image from an original, an image printing unit which prints an image on a paper sheet on the basis of image data, and a first image processing unit which performs an image process for image data, and the information processing apparatus including a second image processing unit which performs an image process for image data, comprising a search key input unit which allows a user to input a search key used for a search for an image processing function, a search unit which searches for at least an image processing function, of image processing functions provided by the first and second image processing units, which is provided by the second image processing unit by using the search key input by the search key input unit, and a search result display unit which displays the image processing function searched out by the search unit in an operation window.

According to the seventh aspect of the present invention, there is provided an image printing system further comprising a search result storage unit which stores a search result obtained by the search unit described in the sixth aspect.

According to the eighth and ninth aspects of the present invention, there is provided an image printing system in which the search unit described in the sixth and seventh aspects outputs a coincidence degree for each search target which numerically expresses a correspondence between a search target and the search key, and the search result display unit changes a display layout of an operation window on the basis of the coincidence degree output from the search unit.

According to the 10th aspect of the present invention, there is provided an image printing system in which the parameter type file described in the second aspect is formed from a test file listing parameter types.

As is obvious from the respective aspects described above, according to the present invention, an image printing system constituted by a plurality of image printing apparatuses and an information processing apparatus which are connected to a network can be provided, in which when the user who operates an image printing apparatus is to use an image process provided by the image printing apparatus or information processing apparatus, the user can easily know the contents of each image process, and can easily input parameters necessary for the execution of each image process.

According to the present invention, since the image printing apparatus can display an explanation of each image process on the basis of a HELP file from the information processing apparatus, the user can easily know the contents of each image process.

In addition, according to the present invention, since the image printing apparatus displays a window for allowing the user to easily input parameters necessary for the execution of an image process, on the basis of a parameter type file from the information processing apparatus, the user can easily input the parameters.

Furthermore, according to the present invention, an image printing system constituted by an image printing apparatus and information processing apparatus which are connected to a network can be provided, in which when the user who operates the image printing apparatus is to use an image process provided from the image printing apparatus or information processing apparatus, he/she can easily know a process result which will be obtained by each image process.

According to the present invention, since the user can check what image can be obtained by a specific image process by actually seeing the image, the user operability can be improved.

In addition, according to the present invention, even if adjustment values for each image process are set in a plurality of steps, the user can check an image process result for each adjustment value. This can improve the user operability.

The user can choose between displaying sample images and not displaying them. Since the information processing apparatus gains control of the operation unit of the image printing apparatus executes control operations including this control operation, a user-friendly user interface which is easy for the user to understand can be provided.

For measures to be taken at the time of abnormality, both the image printing apparatus and the information processing apparatus are provided with functions of monitoring a non-response time (timeout) or periodically making inquires and answers so as to detect the presence/absence of, for example, a line abnormality. This makes it possible to cancel a process without causing any hang-up when one of the apparatuses fails or an abnormality occurs in a communication path.

By providing a forced termination button in the operation unit of the image printing apparatus, the user can arbitrarily cancel an image process to restore the image printing apparatus to the normal state.

In addition, according to the present invention, an image printing system constituted by an image printing apparatus and information processing apparatus which are connected to a network can be provided, which allows the user to easily find a desired function of the image processing functions which can be provided for the user from the image printing apparatus or information processing apparatus, select the function, and execute it.

Furthermore, since a search for an image processing function can be made, a function which the user wants to use can be easily found, thus providing an image printing system with excellent operability. The PC server may make a search. In this case, if a change or the like occurs in the search algorithm, a corresponding change is required only on the server side. A high-performance search function can be developed by making an easy change, i.e., a change only on the server side, and can be quickly provided for the user.

Storing a search key and a search result, e.g., coincidence degrees obtained in the search using the search key, and image processing function names corresponding to the obtained coincidence degrees makes it possible to grasp user needs.

Moreover, since the display layout of an operation window, e.g., the display order of image processing function names, can be changed on the basis of the coincidence degrees obtained in a search using a search key, an image printing system with excellent operability can be provided.

The above and many other objects, features and advantages of the present invention will become manifest to those skilled in the art upon making reference to the following detailed description and accompanying drawings in which preferred embodiments incorporating the principle of the invention are shown by way of illustrative examples.

### BRIEF DESCRIPTION OF THE DRAWINGS

FIG. 1 is a block diagram showing the arrangement of an image printing-system according to an embodiment of the present invention;

FIG. 2 is a block diagram showing the schematic arrangement of a digital copying machine 1 shown in FIG. 1;

FIG. 3 is a block diagram showing the arrangement of a PC server 3 shown in FIG. 1;

FIGS. 4 to 10 show several examples of the operation window of a digital copying machine 1 shown in FIG. 1, in which FIG. 4 is a view showing an operation window in the PC server image processing mode in which the user selects an image process, FIG. 5 is a view showing a display window for the search result obtained after the user touches a search start button 45 in the operation window shown in FIG. 4, FIG. 6 is a view showing a window for requesting the user to input parameters necessary for the execution of an image process, FIG. 7 is a view showing a display state when the user touches the HELP button, and the difference between image processes in different versions, FIG. 8 is a view showing an operation window associated with a density process, FIG. 9 is a view showing a display state when the user touches a preview button in the state shown in FIG. 8, and FIG. 10 is a view showing a window for displaying sample images; and

FIGS. 11 and 12 show examples of the function selection window of the digital copying machine 1 shown in FIG. 1, in which FIG. 11 is a view showing a function selection window for searching for an image processing function, and FIG. 12 is a view showing a display window for the search result obtained after the user touches a search start button 45 in the function selection window shown in FIG. 11.

### DETAILED DESCRIPTION OF THE PREFERRED EMBODIMENT

A preferred embodiment of the present invention will be described below with reference to the accompanying drawings.

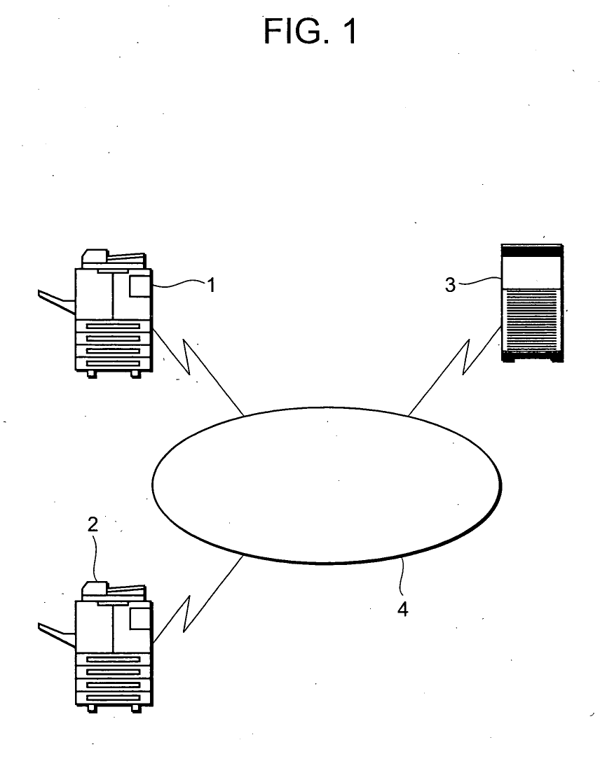

The arrangement and basic operation of an image printing system according to the present invention will be described first with reference to FIG. 1.

An embodiment of the image printing system of the present invention whose system configuration is shown in the block diagram of FIG. 1 will be described by taking an electrophotographic digital copying machine as an image printing apparatus and a PC server as an information processing apparatus.

As shown in FIG. 1, the image printing system of the present invention is formed by connecting digital copying machines 1 and 2 and a PC server 3 through a network 4.

Each of the digital copying machines 1 and 2 can read (scan) an original and perform image printing (print) by itself. In addition, since they are connected to the network 4, for example, the image read by the digital copying machine 1 can be transferred to the digital copying machine 2 to make the digital copying machine 2 perform image printing, and vice versa. That is, the image read by the digital copying machine 1 or 2 can be transferred to another apparatus through the network 4, and the image received from another apparatus through the network 4 can be printed by the digital copying machine 1 or 2.

In addition, in the image printing system of the present invention, the PC server 3 is also connected to the network 4. The PC server 3 can perform a predetermined image process for the image data received from the digital copying machine 1 or 2, and return the resultant data to the transmission source. Alternatively, for example, a predetermined image process is performed for the image data received from the digital copying machine 1, and the resultant data may be transferred to the digital copying machine 2 instead of the transmission source.

Referring to FIG. 1, the network 4 may be any kind of network such as a LAN, e.g., Ethernet (registered trademark) or token-ring, or the Internet. Network addresses are respectively set in the apparatuses connected to the network 4. The respective apparatuses are identified by these addresses and communicate with other apparatuses connected to the network 4.

Referring to FIG. 1, a one-to-many relationship is established between the PC server which is an image processing server, i.e., an information processing apparatus, and the digital copying machines, i.e., image printing apparatuses. Obviously, however, a one-to-one, many-to-one, or many-to-many relationship may also be established.

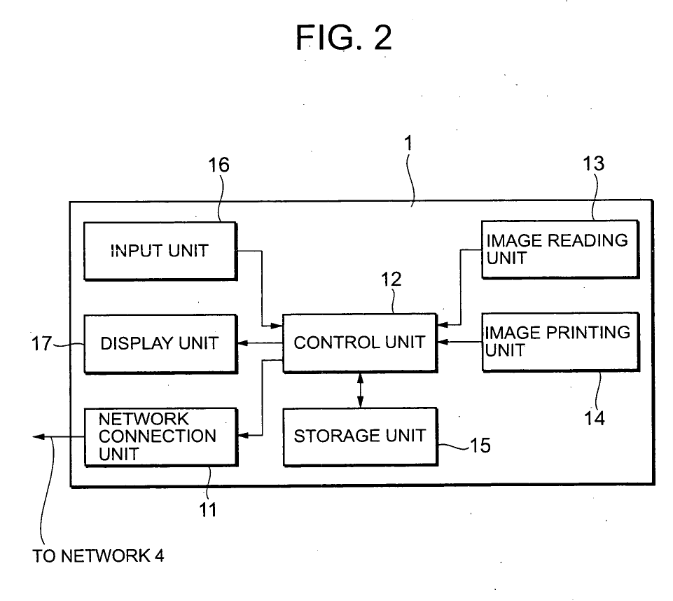

FIG. 2 is a block diagram showing the arrangement of the digital copying machine 1 in FIG. 1.

Since the digital copying machines 1 and 2 shown in FIG. 1 have the same basic arrangement associated with the image printing system, the digital copying machine 1 will be representatively described below.

The digital copying machine 1 is comprised of a network connection unit 11 serving as an interface with the network 4 in FIG. 1, a control unit 12 which controls the overall operation of the digital copying machine 1, an image reading unit 13 which reads an image from an original, an image printing unit 14 which prints an image on a paper sheet or the like, a storage unit 15 which stores software programs for image processes for image data inside the digital copying machine 1 and the like as well as the image data read by the image reading unit 13, parameters and software programs necessary for the operation of the digital copying machine 1, and the like, an input unit 16 by which the user inputs operation instructions and the like to the digital copying machine 1, and a display unit 17 which displays various kinds of information to the user. Note that the input unit 16 and display unit 17 can be integrated into an operation window such as a touch panel. This embodiment exemplifies a case wherein the digital copying machine 1 has such an integrated operation window.

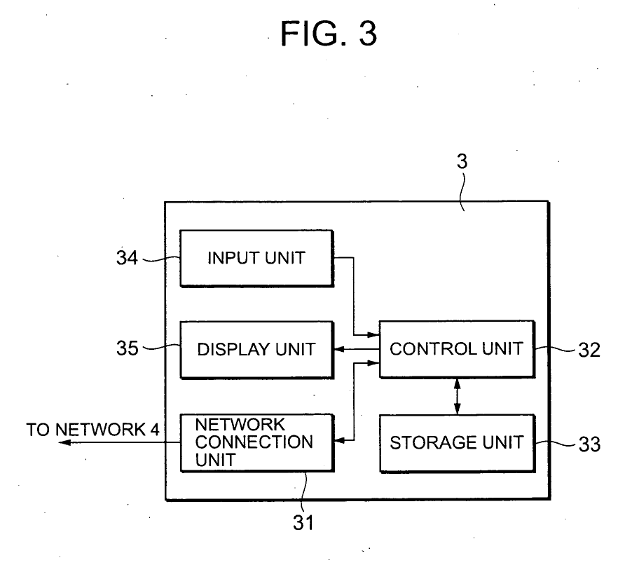

FIG. 3 is a block diagram showing the arrangement of the PC server 3 in FIG. 1.

The PC server 3 is comprised of a network connection unit 31 serving as an interface with the network 4 in FIG. 1, a control unit 32 which controls the overall operation of the PC server 3, a storage unit 33 which stores image data, software program files which implement image processes to be executed for image data, HELP files in which image processing function explanations and the like are written, parameter type files in which the types of parameters necessary to execute the respective image processes are written, parameters necessary for the operation of the PC server 3, and the like, an input unit 34 by which the user inputs operation instructions and the like to the PC server 3, and a display unit 35 which displays various kinds of information to the user of the PC server 3. As the input unit 34, for example, a keyboard or mouse is used. As the display unit 35, a display apparatus or the like is used.

The control unit 32 reads out a software program file which is stored in the input unit 34 and used to implement an image process, and executes the file, thereby implementing the image process.

The image processing operation of the image printing system of the present invention will be described next.

Note that in the following description, target image data for which image processes are to be performed may be data read by the image reading unit 13, data stored in the storage unit 15 in advance, and data externally received by the network connection unit 11.

Each of the digital copying machines 1 and 2 connected to the network 4 issues a request for an image processing program list to the PC server 3. In this case, each digital copying machine transmits its own model information (stored in, for example, the storage unit 15 in advance) as well as issuing the image processing program list request.

The image processing program list is a list of image processes which can be executed by the PC server 3, i.e., a list of image processing programs which the PC server 3 has. The detailed contents of these programs will be described later.

Model information is information which is required by the PC server 3 to specify image processes which can be handled by the corresponding digital copying machine. This mode information includes, for example, information indicating whether the corresponding machine is a color or monochrome machine, a compatible resolution or bit count, and the like.

Upon receiving an image processing program list request and model information from a digital copying machine, the PC server 3 creates an image processing program list on the basis of the received model information and information about image processing programs which the PC server 3 itself possesses (which is stored in, for example, the storage unit 33 in advance).

The PC server 3 also stores the frequency of use of each image processing program which has been executed by the digital copying machine which has issued the image processing program list request. In the image processing program list, for example, image processing programs are listed in the order of decreasing frequency of use. The digital copying machine which has received this image processing program list can know image processes which the user of the machine often uses, and can use the corresponding information to determine the display order of programs in the operation window of the machine itself.

Upon creating the image processing program list, the PC server 3 transmits the image processing program list to the digital copying machine which has issued the request. In this manner, an image processing function is notified.

Upon receiving the image processing program list, the digital copying machine displays image processes which can be provided for the user or their names on the basis of the list.

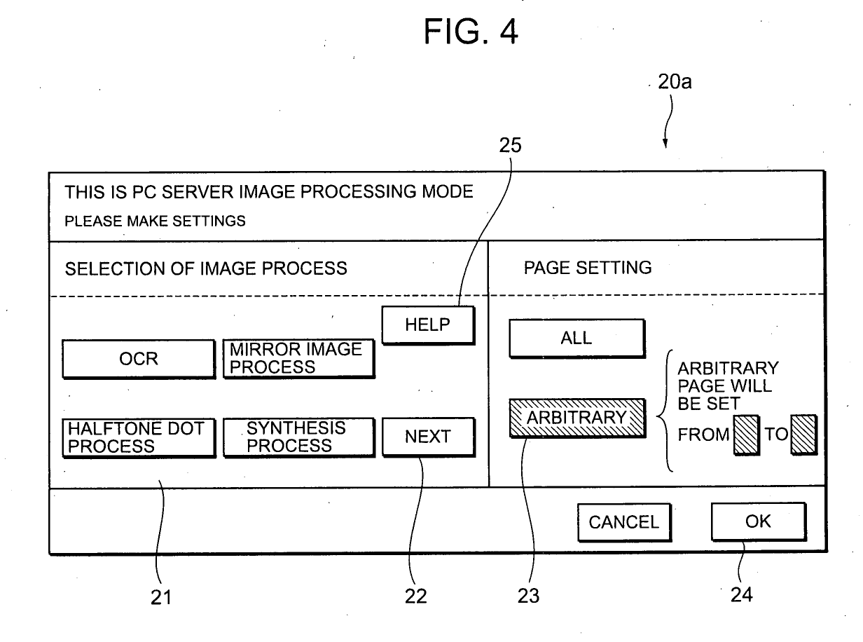

FIG. 4 is a view showing an example of an operation window in image processing by the digital copying machine 1 shown in FIG. 1.

An operation window 20a shown in FIG. 4 corresponds to the input unit 16 and display unit 17 shown in FIG. 2. This window is a touch panel input type operation window which is designed such that when the user touches a portion on which an image process name or the like is displayed, the corresponding information is detected by the digital copying machine 1.

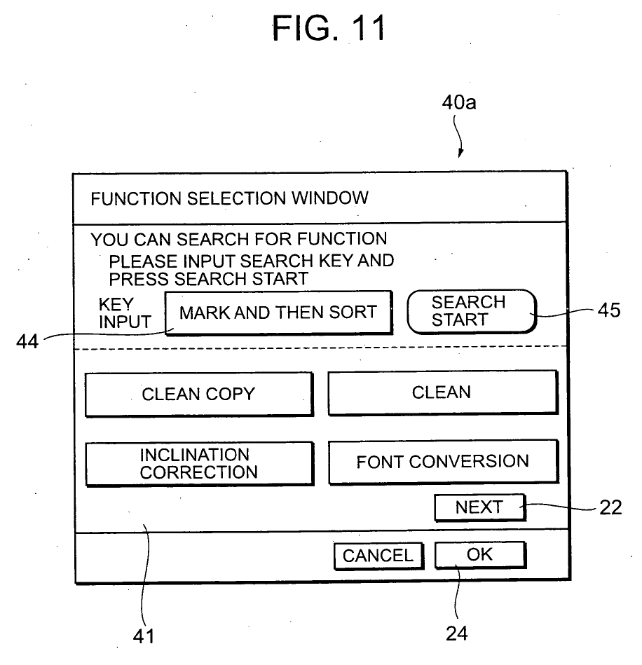

As shown in FIG. 11, an operation window can also be displayed as a function selection window which allows the user to select a desired function of the image processing functions provided by the digital copying machine 1 or the PC server 3 connected to the digital copying machine 1 through the network 4.

The digital copying machine 1 displays the names of image processing functions which can be provided for the user on the display unit 17, i.e., an image process name display area 21 of the operation window 20a shown in FIG. 4, on the basis of the image processes listed in the image processing program list received from the PC server 3 and the types of image processes which can be internally provided by the digital copying machine 1 itself.

As described above, according to the image printing system of the present invention, the digital copying machine 1 displays, to the user, the names of image processes which can be provided to the user, on the basis of information (registered in, for example, the storage unit 15 in advance) about image processes which can be internally provided by the digital copying machine 1 and the image processing program list created by the PC server 3 on the basis of the model information of the digital copying machine 1. This prevents the user from selecting any image process which cannot be executed, and hence can avoid confusion in operation.

All image process names may not be displayed in one window due to the limited space in the image process name display area 21 of the operation window 20a. For this reason, the image printing system of the present invention has a next window button 22. When the user touches the next window button 22, the next window is displayed to display image process names which cannot be displayed in one window.

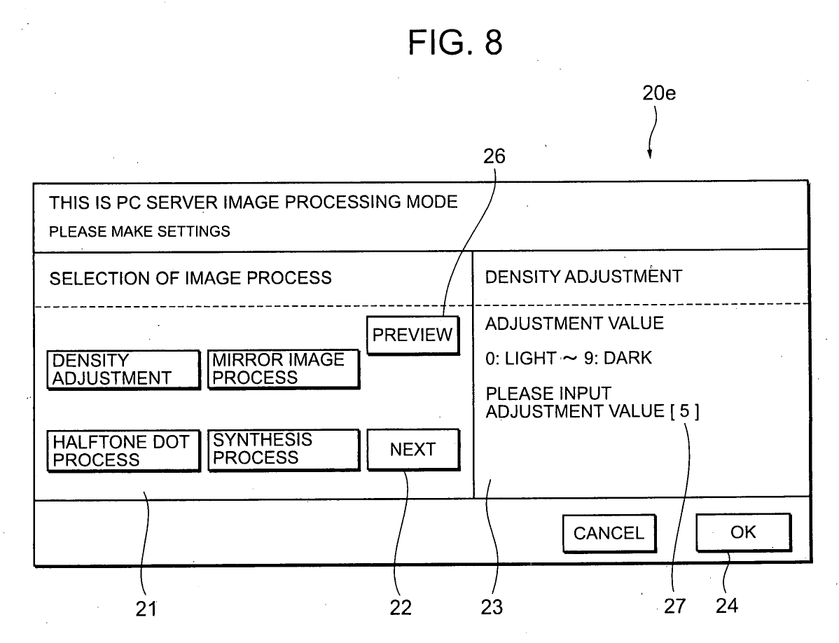

Specific positions in the image process name display area 21 at which specific image process names should be displayed are preferably determined on the basis of the frequency of use of each image process which can be known from the image processing program list or the frequency of use of each image processing program which has been executed by the digital copying machine 1 itself (stored in, for example, the storage unit 15 in advance). For example, the first most frequently used image process (“OCR” in the case shown in FIG. 4, “density adjustment” in the case shown in FIG. 8, and “clean copy” in the case shown in FIG. 11) is displayed at an upper left position; the second most frequently used image process (“mirror image process” in the cases shown in FIGS. 4 and 8, and “clean” in the case shown in FIG. 11), at an upper right position; the third most frequently used image process (“halftone dot process” in the cases shown in FIGS. 4 and 8, and “inclination correction” in the case shown in FIG. 11), at a lower left position; and the fourth most frequently used image process (“synthesis process” in the cases shown in FIGS. 4 and 8, and “font conversion” in the case shown in FIG. 11), at a lower right position. Subsequent processes are displayed in the next window set when the user touches the next window button 22.

When a desired image process is selected (a button on which an image processing function name is written is touched), the user can instruct the digital copying machine 1 to execute the selected image process by touching an OK button 24.

Upon selecting an image process, the user can select a specific page of image data for which the image process should be executed. In the case shown in FIG. 4, an arbitrary button 23 which is hatched (grayed out) in the actual operation window 20a indicates that the button cannot be selected even if the user touches it.

Of the image processes, some image processes allow a plurality of types of image processes to be simultaneously executed for image data depending on the processing. In such a case, upon sequentially selecting such image processes, the user can issue an instruction to execute a plurality of image processes by touching the OK button 24. Of a plurality of types of image processes, some processes cannot be simultaneously executed. In such a case, a button corresponding to a process that cannot be selected is preferably grayed out, like the arbitrary button 23 shown in FIG. 4, to inhibit the user from selecting it.

When the user selects any image process (touches a button corresponding to the name of the image process) in the operation window 20a of the digital copying machine 1, the control unit 12 detects it, and the corresponding information is transmitted by the network connection unit 11 to the PC server 3 through the network 4.

In the PC server 3 which has received the information through the network connection unit 31, the control unit 32 controls the network connection unit 31 to transmit a signal for requesting control of the operation unit of the digital copying machine 1, i.e., the input unit 16 and input unit 16, to the digital copying machine 1 through the network 4. This arrangement corresponds to a control requesting unit.

In response to this request, the digital copying machine 1 causes the network connection unit 11 to transmit a signal for permitting the PC server 3 to gain control of the operation unit of the digital copying machine 1 to the PC server 3 through the network 4. This arrangement corresponds to a control permission unit.

Upon receiving this signal, the PC server 3 controls the operation unit of the digital copying machine 1. This arrangement corresponds to an operation unit control unit. More specifically, the contents displayed on the operation unit of the digital copying machine 1 are all the data transmitted from the PC server 3 to the digital copying machine 1, which include a layout, framework, text to be displayed, and the like. The contents input by the user through the operation unit of the digital copying machine 1 are sent to the PC server 3. The PC server 3 then executes a process based on the input contents.

When the PC server 3 controls the control unit of the digital copying machine 1, an adjustment parameter input area 23 required when the image process selected by the user is to be executed is displayed in the operation window 20a of the operation unit of the digital copying machine 1. That is, the contents displayed in the operation window 20a are stored in the storage unit 33 of the PC server 3 in advance, and read out by the control unit 32, as needed, to be transmitted by the network connection unit 31 to the digital copying machine 1 through the network 4 and displayed on the operation unit of the digital copying machine 1.

As described above, according to the image printing system of the present invention, the names of image processes which the user often uses can be displayed at positions which allow easy operation by the user, thereby providing a user-friendly operation window. In addition, graying out any icon which cannot be selected can prevent the user from being confused in operation.

As shown in FIG. 4, the image printing system of the present invention has a HELP button 25 in the operation window 20a. When the user touches the HELP button 25, an explanation of the currently selected image process is displayed.

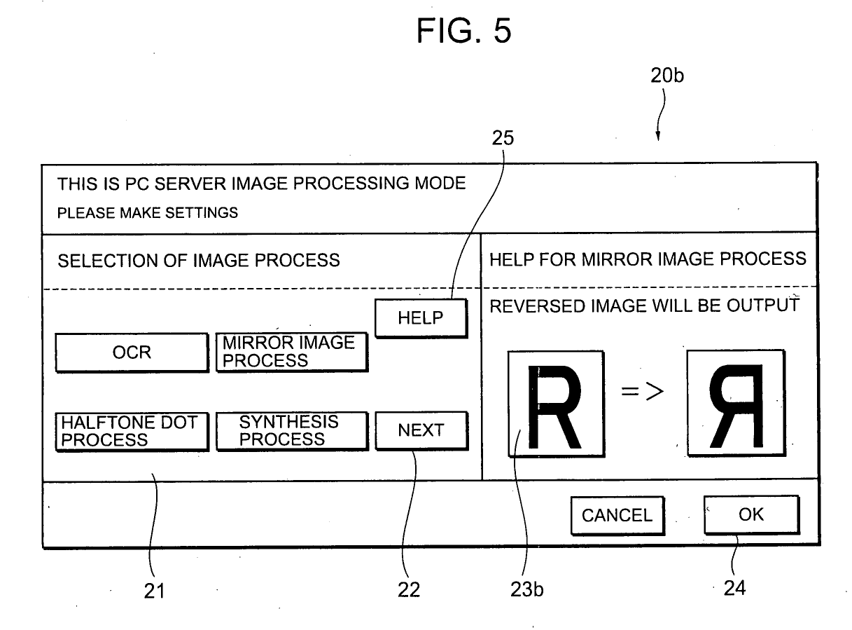

When, for example, the user touches the HELP button 25 after touching the mirror image process button in FIG. 4, the mirror image process is selected, and an explanation of the mirror image process is displayed. The manner of displaying such an explanation will be described in more detail below with reference to FIG. 5.

As shown in FIG. 5, when the user touches the HELP button 25, a process explanation display area 23b is provided in an operation window 20b. An explanation of the currently selected image process (FIG. 5 shows a state wherein the mirror image process is selected) is displayed in the process explanation display area 23b. The control unit 12 selects this explanation from HELP files in which the function explanations of the respective image processes are contained in the image processing program list received by the digital copying machine 1 from the PC server 3, and displays the explanation. This arrangement corresponds to an explanation display unit which displays an explanation of an image process on the basis of the HELP file received from the image processing apparatus.

With this operation, the user can know what is the mirror image process. In addition, as shown in FIG. 5, since a relatively wide area can be ensured as the process explanation display area 23b, a detailed explanation of each image process can be displayed, and what the image will actually become can be displayed (FIG. 5 shows what will become of “R” after the mirror image mirror process).

In this embodiment, an image processing program list contains HELP files, and the digital copying machine 1 receives in advance HELP files associated with the respective image processes altogether from the PC server 3. However, the present invention is not limited to this. For example, every time the user touches the HELP button 25, the digital copying machine 1 may inquire the PC server 3 about a HELP file associated with the currently selected image process to receive it.

When the user touches the HELP button 25, if there are not contents to be displayed, the HELP button 25 in the operation window 20a is preferably grayed out to let the user know that the function cannot be used.

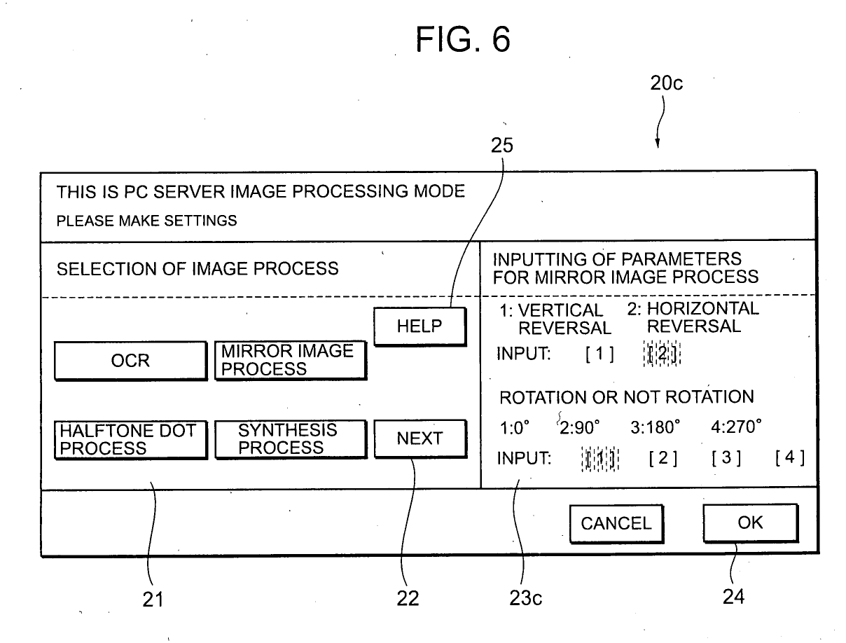

The image printing system of the present invention provides a unit which inputs various kinds of parameters necessary for each image process. This will be described with reference to FIG. 6.

FIG. 6 is a view showing another example of the operation window on the digital copying machine 1 shown in FIG. 1, which is a window for requesting the user to input parameters necessary for the execution of image processes.

An operation window 20c shown in FIG. 6 has a parameter input area 23c which requests the user, who has selected a mirror image process, to input parameters necessary for the execution of the mirror image process. This arrangement corresponds to a parameter input requesting unit which requests the user to input parameters necessary for the execution of an image process on the basis of the parameter type file received from the information processing apparatus.

In the parameter input area 23c, the control unit 12 selects and displays one of the parameter type files in which the types of parameters necessary for the execution of the respective image processes are contained in the image processing program list received by the digital copying machine 1 from the PC server 3. In a specific operation sequence, when the user touches the mirror image process button in the image process name display area 21, the parameter input area 23c shown in FIG. 6 may be displayed.

In the case of a mirror image process, since the mirror image process provides a vertically reversing function and a horizontally reversing function, the parameter input area 23c prompts the user to select either of them. In addition, since an image can be rotated in the mirror image process, the parameter input area 23c also prompts the user to select a rotational angle. That is, in this mirror image process, the type of reversing function and a rotational angle are parameters.

Default values may be set in advance for these parameters. When the user selects nothing, an image process may be executed on the basis of the default values. Depending on the types of parameters, the user may actually input values and designate the execution of the process instead of selecting preset values.

In the digital copying machine 1, a framework for the display of the parameter input area 23c is preferably stored in the storage unit 15 in advance. This allows a parameter type file received from the PC server 3 to be formed from a text file listing the types of parameters, and hence can eliminate the necessity to receive an image file as a framework for display from the PC server 3. Therefore, the amount of data transferred can be reduced.

When the user is to actually execute an image process using the PC server 3 by operating the digital copying machine 1, the user operates the operation window 20c to select a desired image process and necessary parameters and designate the execution of the process. The digital copying machine 1 then transfers the information of the contents of the image process (the type of image process, parameters necessary for the execution of the image process, and the like) and image data as an image process request to the PC server 3. Upon receiving this request, the PC server 3 causes the control unit 32 to perform the requested image process for the image data, and returns the resultant image data to the digital copying machine 1.

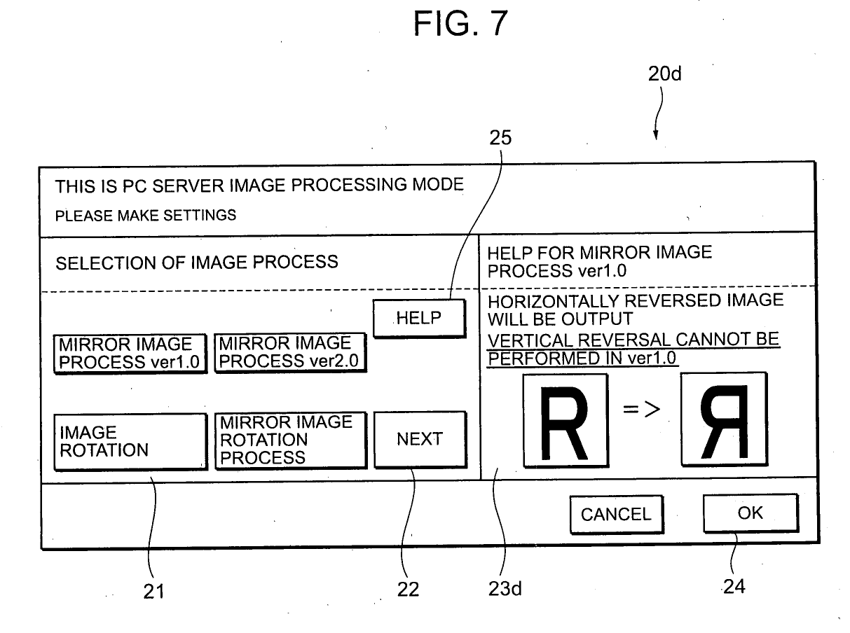

According to the above description, a function explanation of each type of image process is displayed when the user touches the HELP button 25. However, the present invention is not limited to this. For example, if identical image processes in different versions differ in function, the corresponding information can be displayed to the user. This point will be described with reference to FIG. 7.

FIG. 7 is a view showing still another example of the operation window of the digital copying machine 1 shown in FIG. 1. FIG. 7 shows a display state when the user touches the HELP button 25, and the difference between identical image processes in different versions.

In an operation window 20d shown in FIG. 7, as image processes which can be selected by the user, “mirror image process ver1.0”, “mirror image process ver2.0”, “image rotation”, and “mirror image rotation process” are prepared.

FIG. 7 also shows a state wherein the user has selected mirror image process ver1.0, and an explanation of this process is displayed. At this time, a characteristic feature of mirror image process ver1.0 is displayed in a process explanation display area 23d to allow the user to understand differences from other image processes. Upon referring to this explanation, the user can know which image process he/she wants to execute.

The image printing system of the present invention can display the differences in function and other capabilities (e.g., processing speed) and the like between identical image processes in different versions, and can also clearly display and inform the user of the characteristic features of image processes when their names are similar and hence the user tends to be confused.

FIG. 8 is a view showing still another example of the operation window associated with image processes in a case wherein the user has selected “density adjustment”.

In this case, when the user selects the image process “density adjustment” which is a process of adjusting the density of an image, the user is to input the density level of an image after the image process as an adjustment parameter in the density adjustment.

The user operates, for example, the ten-key pad provided for the input unit 16 to input a desired value in an adjustment value input section 27. When this operation is complete, the user touches the OK button 24. This makes it possible to designate the execution of “density adjustment” by using the density level (one of the numerals 0 to 9 in the image printing system of the present invention) input in the adjustment value input section 27 by the user (transmit the input information to the PC server 3).

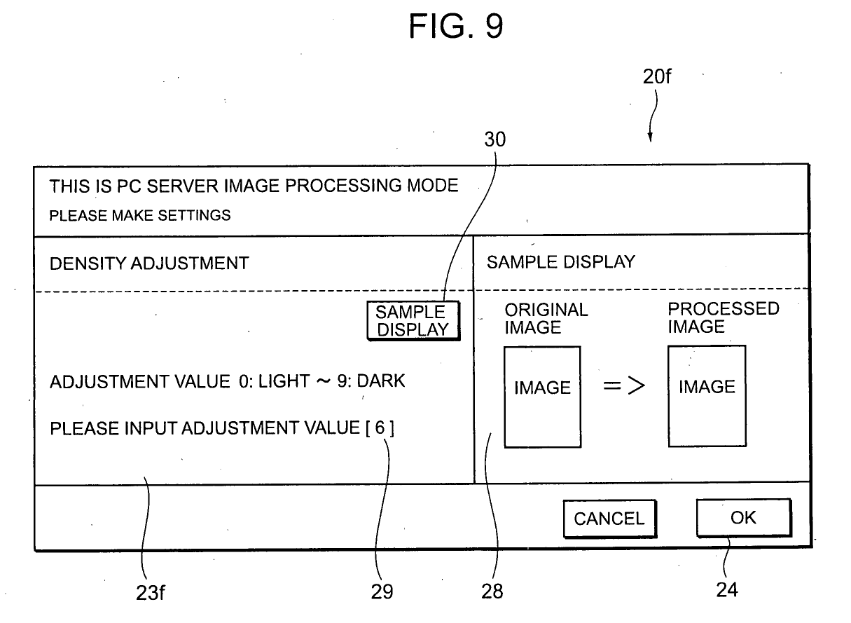

In an operation window 20e shown in FIG. 8, although the user can know that the adjustment value 0 indicates a low density, and the density increases with an increase in numerical value, he/she cannot know how much the image actually becomes dark. The image printing system of the present invention therefore has a preview button 26 as shown in FIG. 8. When the user touches the preview button 26, a preview image is displayed to allow the user to check what will become of an image when an image process is executed with the current adjustment parameter. This arrangement corresponds to a sample display unit. This point will be described in more detail below with reference to FIG. 9.

FIG. 9 is a view showing still another example of the operation window of the digital copying machine 1 shown in FIG. 1. FIG. 9 shows a display state when the user touches the preview button 26 in the state shown in FIG. 8.

As shown in FIG. 9, when the user touches the preview button 26 in the state shown in FIG. 8, the corresponding information (information indicating that the preview button 26 is touched, image data at this time, and the type of image process (“density adjustment” in FIG. 8) which is currently selected to be executed for the image data, the value (5 in FIG. 8) currently input as an adjustment parameter to be used for the image process, and the like) is transmitted to the PC server 3. The PC server 3 executes the image process on the basis of the received information, and creates a processed image. The PC server 3 then transmits, to the digital copying machine 1, information (including the image data of the processed image) to be displayed on the operation unit of the digital copying machine 1. This information is displayed on the digital copying machine 1. That is, a parameter input area 23f and sample image display area 28 are displayed in an operation window 20f, as shown in FIG. 9.

At this time, an image for which the user is to perform an image process is displayed (in the form of, for example, a thumbnail) as an original image in the sample image display area 28. In addition, as a processed image, the image obtained by executing the image process with the adjustment value input in the adjustment value input section 27 when the user touches the preview button 26 in FIG. 8 is displayed (in the form of, for example, a thumbnail).

This allows the user to know what will become of the original image when the image process is actually executed with the adjustment value currently selected by himself/herself. The user can therefore know a specific adjustment value to be set to obtain a desired image, thus improving the operability.

As shown in FIG. 9, the parameter input area 23f has an adjustment value input section 29 and sample display button 30. This makes it possible for the user to change the adjustment value, i.e., the density level, while referring to the processed image displayed in the sample image display area 28. That is, when the user inputs a desired adjustment value in the adjustment value input section 29 and touches the sample display button 30, the corresponding information (information indicating that the sample display button 30 is touched, the image data at this time, the type of image process (“density adjustment” in FIG. 9) which is currently selected to be executed for the image data, the value (6 in FIG. 9) currently input as an adjustment parameter to be used for the image process, and the like) is transmitted to the PC server 3. The PC server 3 executes the image process on the basis of the received information, and creates a processed image. The PC server 3 then transmits, to the digital copying machine 1, information (including the image data of the processed image) to be displayed on the operation unit of the digital copying machine 1. In the digital copying machine 1, the processed image displayed in the sample image display area 28 of the operation window 20f is changed to the currently received processed image.

Note that as an original image or processed image to be displayed in the sample image display area 28, for example, a user image for which an image process should be performed may be reduced to be entirely displayed. Alternatively, part of a user image may be displayed in the sample image display area 28. In this case, the digital copying machine 1 may have a part designating unit which allows the user to designate a part to be displayed.

The user adjusts the adjustment value while referring to the processed image displayed in the sample image display area 28. When an adjustment value with which a desired image can be obtained is determined, the user touches the OK button 24. This makes it possible to designate the execution of “density adjustment” by using the density level input in the adjustment value input section 29 by the user (transmit the input information to the PC server 3). Upon receiving this information, the PC server 3 causes the software in the control unit 12 to execute the image process (image processing unit) in accordance with the designated contents. When the image process is complete, the PC server 3 transmits the image data of the processed image to the digital copying machine 1. Upon receiving the image data of the processed image, the digital copying machine 1 causes the image printing unit 14 to print the image, as needed.

The operation of the OK button 24 is operation input indicating an escape from the image processing window eventually (an escape from the image processing window may be made by cancel button input). When operation input indicating an escape from the image processing window is informed to the PC server 3, the PC server 3 causes the network connection unit 31 to transmit a signal for releasing control of the operation unit, i.e., the input unit 16 and display unit 17, of the digital copying machine 1 to the digital copying machine 1 through the network 4. Upon receiving this signal, the digital copying machine 1 regains control of the operation unit, i.e., the input unit 16 and display unit 17, of the digital copying machine 1.

Still another example of the operation window of the digital copying machine 1 will be described next.

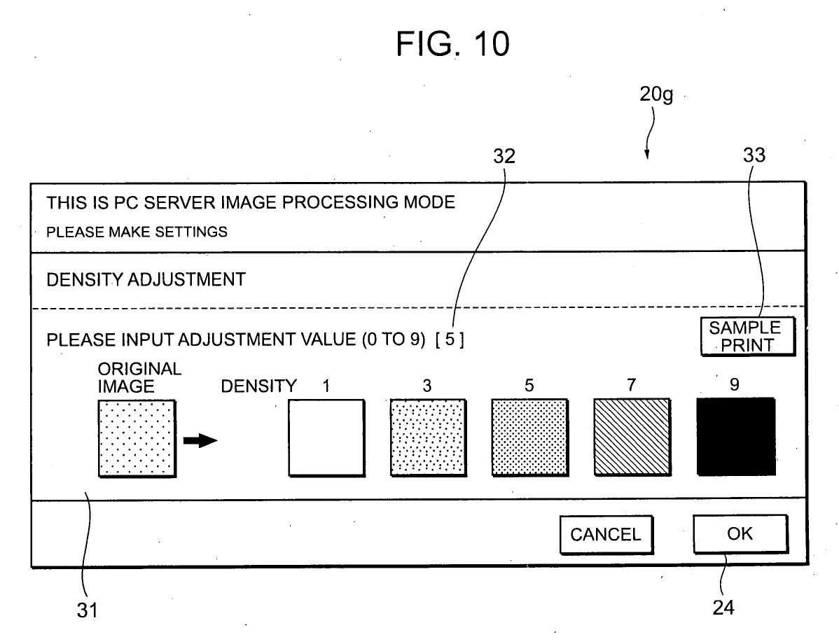

FIG. 10 is a view showing still another example of the operation window of the digital copying machine 1 shown in FIG. 1. FIG. 10 shows a window for displaying sample images, which is another example of the window shown in FIG. 9.

That is, as another example of the window shown in FIG. 9, an operation window 20g shown in FIG. 10 is displayed on the operation unit of the digital copying machine 1 when the user touches the preview button 26 in the state shown in FIG. 8.

In the case shown in FIG. 9, the processed image obtained when the image process is executed by using the adjustment value input in the adjustment value input section 29 is displayed in the sample image display area 28. In the case shown in FIG. 10, an original image is displayed in a sample image display area 31, together with the processed images obtained when density adjustment as an image process is performed for the original image with a plurality of different density levels. That is, the window in FIG. 10 displays the image obtained by performing density adjustment with the adjustment value 1, the image obtained by performing density adjustment with the adjustment value 3, the image obtained by performing density adjustment with the adjustment value 5, the image obtained by performing density adjustment with the adjustment value 7, and the image obtained by performing density adjustment with the adjustment value 9. Processed images with arbitrary adjustment values can be displayed.

The user refers to these processed images to select an adjustment value for density adjustment which he/she wants to execute, and inputs the selected value in an adjustment value input section 32. By touching the OK button 24 afterward, the user can designate the execution of density adjustment using the density level input in the adjustment value input section 32 by the user as an adjustment parameter (transmit the input information to the PC server 3).

Note that a sample print button 33 is provided in the operation window 20g shown in FIG. 10. When the user touches the sample print button 33 after inputting an adjustment value in the adjustment value input section 32, an image whose density is adjusted by using the adjustment value input in the adjustment value input section 32 can be actually printed by the image printing unit 14.

The image printed when the user touches the sample print button 33 is not limited to the image whose density is adjusted by using the adjustment value input in the adjustment value input section 32, and a plurality of processed images obtained when density adjustment as an image process is performed for the original image with a plurality of different density levels may be printed.

According to the above description, density levels are adjustment parameters. However, the present invention is not limited to this. Various adjustment parameters are present for each type of image process, and processed images obtained by adjusting the parameters are displayed.

It may take some time to perform a process of displaying sample images on an operation window, a unit which allows the user to choose between performing sample display and not performing it is preferably provided. This unit is a sample display selection unit. This unit can also be implemented when the PC server gains control of the operation unit of the digital copying machine (control of display with respect to the display unit and acquisition of the information input by the input unit).

For measures to be taken at the time of abnormality, both the image printing apparatus and the information processing apparatus are provided with functions of monitoring a non-response time (timeout) or periodically making inquires and answers so as to detect the presence/absence of, for example, a line abnormality. This makes it possible to cancel a process without causing any hang-up when one of the apparatuses fails or an abnormality occurs in a communication path.

By providing a forced termination button for the operation unit of the image printing apparatus, the user can arbitrarily cancel an image process to restore the image printing apparatus to the normal state.

The image printing system of the present invention allows the user to search for an image processing function. Note that a function selection window for a search for an image processing function may be displayed separately from a conventional window in which image processing functions are displayed to be selected.

In the case shown in FIG. 11, the functions “clean copy”, “clean”, “inclination correction”, and “font conversion” are displayed in an image process name display area 41.

As shown in FIG. 11, a function section window 40a has a search key input field 44. Upon inputting a search key in the search key input field 44, the user touches a search start button 45. The user may use character input buttons (not shown) to input a search key in the search key input field 44. This input result is detected by the control unit 12. This arrangement corresponds to a search key input unit.

The control unit 12 of the digital copying machine 1 detects the touch on the search start button 45. The control unit 12 then uses the character string input in the search key input field 44 as a search key, and calculates the coincidence degree between the search key and the name of each of all image processing functions to be displayed in the image process name display area 41 of the function section window 40a (all windows including each transition window displayed when the next window button 22 is touched). This coincidence degree is a numerical expression of the correlation between a search target and the search key.

A coincidence degree can be calculated in the following manner. For example, a search key is written with spaces between words, and the character string of the search key is divided with a postpositional word to extract prime search elements. A search is made to check whether each prime search element is included in the name of each image processing function, and a hit is counted when the element is included. The total number of hits is then obtained for each image processing function. The total number of hits is regarded as a coincidence degree.

Conventionally, various kinds of methods of calculating coincidence degrees have been known. Obviously, coincidence degrees may be calculated by a method other than that described above.

In the case shown in FIG. 11, the character string “MARK AND THEN SORT” is input as a search key in the search key input field 44. In this case, “MARK” and “SORT” are prime search elements.

In the above case, the coincidence degree between the name of each image processing function and the search key is obtained. However, the present invention is not limited to this. For example, a keyword may be registered in advance for each image processing function and stored in the storage unit 15, and the coincidence degree between each keyword and a search key may be calculated. The above arrangement corresponds to a search unit.

The calculation result information of a coincidence degree for each image processing function, which is obtained in the above manner, and information indicating what is a search key used for the calculation are stored as a database in the storage unit 15, and can be statistically used. This arrangement corresponds to a search result storage unit.

The information in the form of a database can be used to analyze user needs. Assume that with regard to the image processing functions which can be currently provided by the image printing system, a search key to which only functions exhibiting low coincidence degrees correspond occurs with high frequency. Since this indicates that users want to be provided with an image processing function exhibiting a high coincidence degree with respect to the search key, this information can be used in developing a new image processing function and planning the installation of an image processing function in the image printing system.

Subsequently, coincidence degrees are calculated for the respective image processing functions, and the control unit 12 extracts image processing functions exhibiting coincidence degrees higher than a predetermined coincidence degree (threshold), and displays the names of the extracted image processing functions in the function section window 40a. In this case, the display order of the names is preferably determined to be the order of decreasing coincidence degree. Note that control may be performed to display all the image processing functions in the order of decreasing coincidence degree without extracting image processing functions exhibiting coincidence degrees higher than the predetermined coincidence degree.

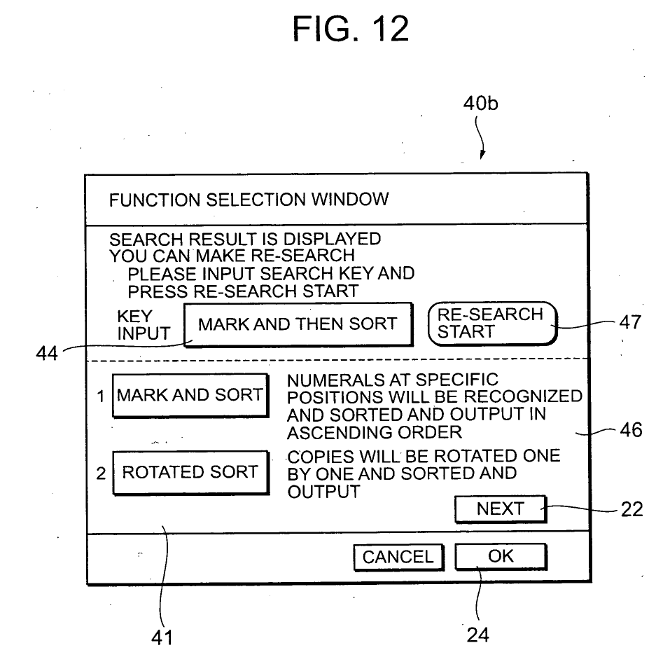

FIG. 12 is a view showing another example of the function selection window of the digital copying machine 1 shown in FIG. 1. FIG. 12 shows a display window for the search result obtained after the user touches the search start button 45 in the function section window 40a shown in FIG. 11.

Image processing function names are displayed in an image process name display area 41 of a function selection window 40b on the basis of the search result. In this case, as shown in FIG. 11, the character string “MARK AND THEN SORT” is input as a search key in a search key input field 44. In this case, “MARK” and “SORT” are prime search elements. Since the image processing function “MARK & SORT” includes the two prim search elements “MARK” and “SORT”, the function exhibits a coincidence degree of 2, which is the highest coincidence degree. This function is therefore displayed at the highest position. Since the image processing function “ROTATED SORT” includes the prime search element “SORT”, the function exhibits a coincidence degree of 1, which is the second highest coincidence degree. This function is therefore displayed at the second highest position. If there are a plurality of image processing functions exhibiting the same coincidence degree, they may be displayed in the order of decreasing frequency of use in the past.

As described above, the image printing system of the present invention can change the display layout of an operation window, e.g., the display order of image processing function names, on the basis of the coincidence degrees obtained when a search is made with a search key. Therefore, an image printing system with excellent operability can be provided.

In addition, the control unit 12 displays function explanations of the respective image processing functions in a function explanation display area 46 as well as displaying the names of the image processing functions in the image process name display area 41. The function explanations of the image processing functions may be stored in the storage unit 15 in advance. Alternatively, the function explanations may be stored in the storage unit 33 in advance, and the digital copying machine 1 may receive the explanations from the PC server 3 while they are contained in the image processing program list received from the PC server 3.

All image process names as a search result may not be displayed in one window due to the limited space in the image process name display area 41 of the operation window 40b. For this reason, the image printing system of the present invention has a next window button 22. When the user touches the next window button 22, the next window is displayed to display image process names as the search result which cannot be displayed in one window. The above arrangement corresponds to a search result display unit.

When the user selects a desired image process (touches a button on which the image processing function name is written) and touches the OK button 24, the execution of the selected image process can be designated with respect to the digital copying machine 1.

In addition, the image printing-system of the present invention is designed to be able to make a re-search in the search result display window shown in FIG. 12.

As shown in FIG. 12, the function selection window 40b has the search key input field 44. If the user cannot be satisfied with the current search result and wants to change the search key, he/she inputs a new search key in the search key input field 44, and then touches a re-search start button 47. Upon detecting this operation, the control unit 12 of the digital copying machine 1 performs a re-search by using the character string input in the search key input field 44 as a search key. Since this re-search is performed in the same manner as a search performed when the user touches the search start button 45, a detailed description will be omitted.

In the above case, a search for image processing functions is made by the control unit 12 of the digital copying machine 1. However, the present invention is not limited to this, and this search may be performed by the PC server 3.

More specifically, this operation can be done as follows. Assume that in the function section window 40a shown in FIG. 11, inputting of a search key in the search key input field 44 by the user and a touch on the search start button 45 are detected by the control unit 12. In this case, the control unit 12 transmits the search key input in the search key input field 44 and information requesting a search to the PC server 3 through the network connection unit 11 and network 4, thereby requesting a search for image processing functions.

Upon receiving the image processing function search request and the corresponding search key through the network 4 and network connection unit 31, the control unit 32 searches for the names of image processing functions which are stored in the storage unit 33 in advance and can be provided the PC server 3 itself or keywords registered in correspondence with the respective image processing functions by using the search key received from the digital copying machine 1 in the same manner as described above. In this case, if the search key and the search result, e.g., coincidence degrees obtained in the search using the search key, and image processing function names corresponding to the obtained coincidence degrees, are stored in the control unit 32, these data can be statistically used, as described above.

In addition, the search result is returned to the digital copying machine 1 to be displayed on the digital copying machine 1 in the same manner as the function selection window 40b shown in FIG. 12.

After the user selects a desired image processing function in the above manner, the image processing is executed by the control unit of the apparatus which provides the selected image processing function (software or hardware). The image data having undergone the image process is output onto a paper sheet by the image printing unit 14, as needed.

What is claimed is:

1. An image printing system formed by connecting, through a network, an image printing apparatus which prints an image on a paper sheet on the basis of image data to an information processing apparatus which performs an image process for the image data, said image printing apparatus including image data transmission means for transmitting image data and a type of image process to be performed for the image data to said information processing apparatus, and said information processing apparatus including image processing means for performing a requested image process for image data received from said image printing apparatus, and processed image data transmission means for transmitting the image data having undergone an image process by said image processing means to said image printing apparatus from which the image process has been requested,
wherein said information processing apparatus further includes HELP file transmission means for transmitting, to said image printing apparatus, a HELP file which is an explanation of an image process to be executed by said image processing means, and
said image printing apparatus further includes explanation display means for displaying the explanation of the image process on the basis of the HELP file received from said information processing apparatus.

2. An image printing system formed by connecting, through a network, an image printing apparatus which prints an image on a paper sheet on the basis of image data to an information processing apparatus which performs an image process for the image data, said image printing apparatus including image data transmission means for transmitting image data and a type of image process to be performed for the image data to said information processing apparatus, and said information processing apparatus including image processing means for performing a requested image process for image data received from said image printing apparatus, and processed image data transmission means for transmitting the image data having undergone an image process by said image processing means to said image printing apparatus from which the image process has been requested,
wherein said information processing apparatus further includes parameter type file transmission means for transmitting, to said image printing apparatus, a parameter type file in which a type of parameter necessary for execution of an image process to be executed by said image processing means is written, and
said image printing apparatus further includes parameter input requesting means for requesting a user to input a parameter necessary for execution of an image process on the basis of a parameter type file received from said information processing apparatus.

3. An image printing system formed by connecting, through a network, an image printing apparatus which prints an image on a paper sheet on the basis of image data to an information processing apparatus which performs an image process for the image data,
wherein said image printing apparatus includes an operation unit which displays information to a user and receives an information input from the user, and control permission means for permitting said information processing apparatus to gain control of said operation unit in accordance with a request from said information processing apparatus, and
said information processing apparatus includes control requesting means for requesting control of said operation unit of said image printing apparatus, and operation unit control means for controlling said operation when control of said operation unit is permitted by said control permission means.

4. A system according to claim 3, wherein said operation unit control means includes sample display means for displaying, on said operation unit, a sample image obtained by causing said operation unit to perform an image process designated by the user for an original image.

5. A system according to claim 4, wherein said operation unit control means further includes sample display selection means for allowing the user to select whether or not to cause said sample display means to display a sample.

6. An image printing system formed by connecting, through a network, an image printing apparatus to an information processing apparatus, said image printing apparatus including image reading means for obtaining image data by reading an image from an original, image printing means for printing an image on a paper sheet on the basis of image data, and first image processing means for performing an image process for image data, and said information processing apparatus including second image processing means for performing an image process for image data, comprising:
search key input means for allowing a user to input a search key used for a search for an image processing function;
search means for searching for at least an image processing function, of image processing functions provided by said first and second image processing means, which is provided by said second image processing means by using the search key input by said search key input means; and
search result display means for displaying the image processing function searched out by said search means in an operation window.

7. A system according to claim 6, further comprising search result storage means for storing a search result obtained by said search means.

8. A system according to claim 6, wherein said search means outputs a coincidence degree for each search target which numerically expresses a correspondence between a search target and the search key, and said search result display means changes a display layout of an operation window on the basis of the coincidence degree output from said search means.

9. A system according to claim 7, wherein said search means outputs a coincidence degree for each search target which numerically expresses a correspondence between a search target and the search key, and said search result display means changes a display layout of an operation window on the basis of the coincidence degree output from said search means.

10. A system according to claim 2, wherein the parameter type file is formed from a test file listing parameter types.
